(19) United States
(12) Patent Application Publication
(10) Pub. No.: US 2003/0206482 A1
(43) Pub. Date: Nov. 6, 2003

(54) Extrusion screw tip

(76) Inventor: Jimmy L. Griggs, McPherson, KS (US)

Correspondence Address: OWENS CORNING, 2790 COLUMBUS ROAD, GRANVILLE, OH, 43023, US

(21) Appl. No.: 10/136,166

(22) Filed: May 1, 2002

(51) Int. Cl. B29B 7/48

(52) U.S. Cl. 366/81; 425/204; 425/208; 366/85

(57) ABSTRACT

A tip for an extruder screw includes a body having a first end for attachment to a screw, a second end, and an outer surface. A wiper extends outwardly from an outer surface of the body. In one embodiment, the wiper is a substantially helical conveying flight. In another embodiment the tip includes at least two substantially helical conveying flights on the outer surface of the body.

### TECHNICAL FIELD AND INDUSTRIAL APPLICABILITY OF THE INVENTION

This invention relates to extruders of the type in which a screw rotatable within a barrel is employed to extrude material to a die or mold connected to the outlet end of the barrel, and in particular to an improved tip for a screw in an extruder.

### BACKGROUND OF THE INVENTION

As illustrated in FIG. 1, a typical prior art twin-screw extruder is shown generally at 10. The twin-screw extruder 10 includes a hopper 12 connected to an inlet end 14 of a barrel 16. The barrel 16 includes a longitudinal passage 18. Two screws 19, only one of which is shown in FIG. 1, are rotatably mounted parallel to one another within the passage 18 of the barrel 16. The screws 19 are connected to a source of rotational power (not shown). Each screw 19 is shaped generally in the shape of an elongated cylinder, and has one or more raised ridges helically disposed thereabout. Each helical ridge is typically known as a flight 22. A flight 22 may have a forward pitch or a reverse pitch. As used herein, pitch is defined as a distance 24, as shown in FIG. 1, between two consecutive flights 22. Each flight 22 cooperates with the inner surface of the barrel passage 18 to define an elongated helical channel 26. A die 28 having a die opening 30, or other form of restricted orifice is connected to an outlet end 32 of the barrel 16. An adapter 34 having an adapter cavity 37 may be mounted between the barrel 16 and the die 28. The adapter cavity 37 is typically tapered from a larger cross-sectional area, generally equal to the cross-sectional area of the outlet of the barrel 16, to a smaller cross-sectional area adjacent the die opening 30. A smooth, substantially conically shaped tip 38 is typically attached to the distal end of the screw 19 and extends axially into the adapter cavity 37.

In a typical extrusion process, a polymeric material, such as polyvinyl chloride (PVC) or acrylic, in pellet or powder form is introduced into the hopper 12. The polymeric material is carried forwardly from the hopper 12 along the inside of the barrel 16, through the helical channels 26, by the screws 20. The working of the material generates heat, and the polymeric material is melted as it proceeds toward the die 28. Additional heat may also be applied though the barrel 16 or through the screws 20. The rotating screws 20 thereby act as a pump and push the material through the die opening 30.

### SUMMARY OF THE INVENTION

The invention relates to a tip for an extruder screw. The tip includes a body having a first end for attachment to a screw, a second end, and an outer surface. A wiper extends outwardly from an outer surface of the body. Preferably, the wiper is a substantially helical conveying flight. The tip preferably includes at least two substantially helical conveying flights on the outer surface of the body.

According to this invention, there is also provided an extruder for extruding a material. The extruder includes a barrel and a rotatable screw disposed within the barrel. An adapter is mounted to an outlet end of the barrel. The adapter has a wall which defines a cavity. An outlet end of the adapter has a reduced cross-sectional area relative to a cross-sectional area of an inlet end of the adapter. A tip is mounted to an end of the screw and extends into the cavity of the adapter. A flow space is defined between the tip and the wall of the adapter. A wiper extends from a surface of the tip into the flow space. The wiper is adapted to move material within the flow space as the tip rotates.

According to this invention, there is also provided an extruder for extruding a material. The extruder includes a barrel. A first rotatable screw and a second rotatable screw are disposed within the barrel. An adapter is mounted to an outlet end of the barrel. The adapter has a wall which defines a cavity. An outlet end of the adapter has a reduced cross-sectional area relative to a cross-sectional area of an inlet end of the adapter. A first tip is mounted to an end of the first rotatable screw and extends into the cavity of the adapter. A second tip is mounted to an end of the second rotatable screw and extends into the cavity of the adapter. A flow space is defined between the first and second tips and the wall of the adapter. A first wiper extends from a surface of the first tip into the flow space. The first wiper is adapted to move material within the flow space as the first tip rotates. A second wiper extends from a surface of the second tip into the flow space. The second wiper is adapted to move material within the flow space as the second tip rotates.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a cross-sectional view in elevation of a typical prior art twin screw extruder.

FIG. 2 is a partial top view, partially in cross-section of a twin screw extruder showing the screw tips according to the invention.

FIG. 3 is a cross-sectional view in elevation of one of the screw tips of FIG. 2.

FIG. 4 is an end view of the screw tip of FIG. 3.

### DETAILED DESCRIPTION AND PREFERRED EMBODIMENTS OF THE INVENTION

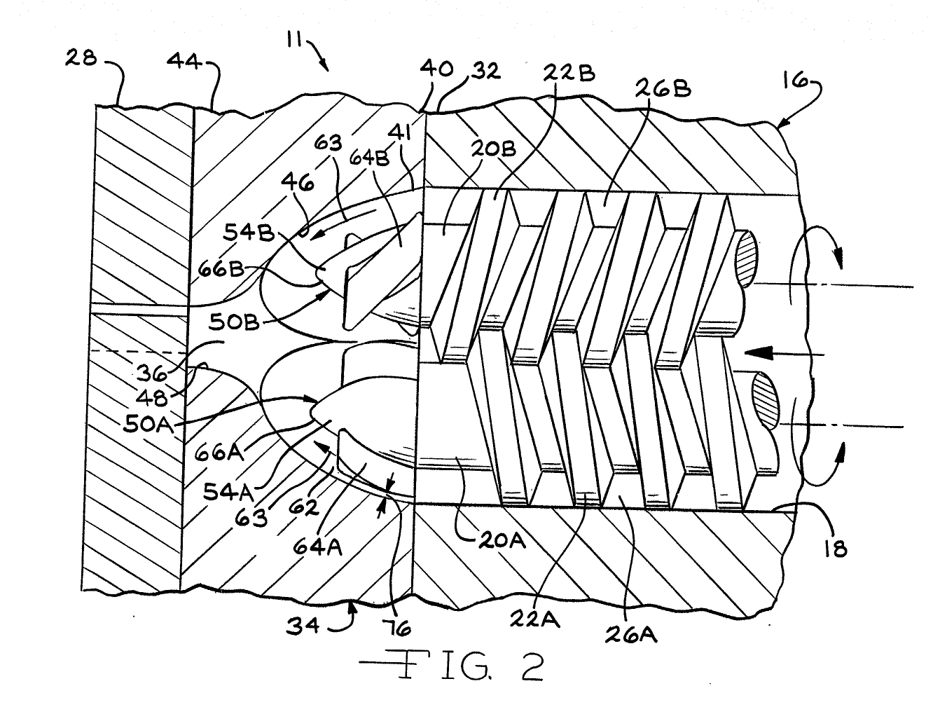

Referring to FIG. 2, a portion of a twin screw extruder is shown generally at 11. The twin screw extruder 11 includes a barrel 16. A longitudinal passage 18 is formed within the barrel 16 for receiving a first rotatable screw 20A and a second rotatable screw 20B. Each screw 20A and 20B includes at least one substantially helical conveying flight 22A and 22B, respectively. The two screws 20A and 20B of the twin-screw extruder 11 may be described as intermeshing, as shown in FIG. 2, if a flight 22A of one screw 20A is disposed within a channel 26B of the other screw 20B of the pair. When a flight of one screw is disposed such that it is adjacent, but not within the channel of the other screw of the pair, the screws may be described as non-intermeshing. If the screws rotate in the same direction, for example, if both screws rotate clockwise or both screws rotate counterclockwise, the screws may be described as co-rotating. If one screw rotates in a direction opposite the other screw, the screws may be described as counter-rotating.

Preferably, the first screw 20A and the second screw 20B are arranged to operate as counter-rotating, intermeshing screws, as shown in FIG. 2. Although not illustrated, it will be appreciated that the first screw 20A and the second screw 20B may be arranged to operate in any suitable arrangement, such as, for example, as counter-rotating, non-intermeshing screws; co-rotating, intermeshing screws; and co-rotating, non-intermeshing screws.

An inlet end 40 of the adapter 34 is mounted to the outlet end 32 of the barrel by any suitable means. Preferably, the adapter 34 is mounted to the barrel 16 by threaded fasteners (not shown). An outlet end 44 of the adapter 34 may be attached to a die 28, or other type of restrictive opening for shaping material. Preferably, the die 28 is mounted to the adapter 34 by threaded fasteners (not shown). Preferably, the material being extruded by the extruder 11 is a polymeric material, such as polyvinyl chloride (PVC) or acrylic. The adapter 34 includes an inner wall 46 which defines the cavity 36. The cavity 36 includes a cavity inlet 41 and a cavity outlet 48. Preferably, the cavity outlet 48 has a reduced cross-sectional area relative to a cross-sectional area of the cavity inlet 41.

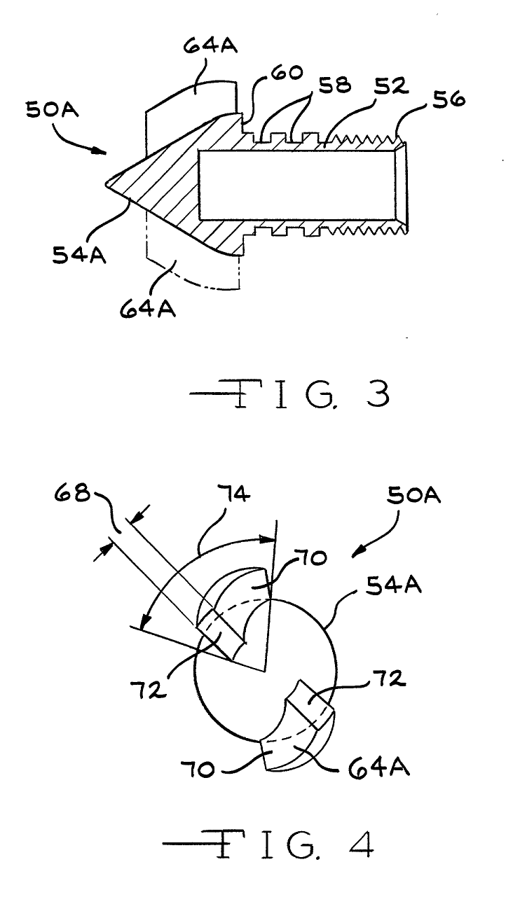

As shown in FIG. 2, the first screw 20A and the second screw 20B include a first tip 50A and a second tip 50B, respectively. Each tip 50A and 50B includes a shaft 52 and a substantially conical body 54A and 54B, respectively. As shown in FIG. 3, the shaft 52 preferably includes external threads 56 for attaching the tips 50A and 50B to the screws 20A and 20B, respectively. One or more annular grooves 58 are provided for receiving a seal, such as an 0-ring (not shown). The bodies 54A and 54B include a sealing surface 60 for sealing engagement with an end of the screws 20A and 20B.

Preferably, the tips 50A and 50B extend axially into the adapter cavity 36. A reduced portion of the cavity 36, or flow space 62 is defined between the tips 50A and 50B and the inner wall 46 of the cavity 36. As material is directed through the extruder 11, it flows through the flow space 62, as shown by the arrows 63. At least one wiper 64A and 64B extends from outer surfaces 66A and 66B of the bodies 54A and 54B, respectively, into the flow space 62. The wipers 64A and 64B are arranged to move material within the flow space 62, as will be described in detail below. Preferably each wiper 64A and 64B has the shape of a substantially helical conveying flight, as shown in FIGS. 2 and 4. More preferably, the tips 50A and 50B include two such spaced apart wipers 64A and 64B, each wiper 64A and 64B having the shape of a substantially helical conveying flight, as shown in FIGS. 2 and 4. Each wiper 64A and 64B has a thickness 68 when viewed from the end of the tip 50A, as shown in FIG. 4, and includes a pushing or downstream side 70 and an end face 72. The wipers 64A and 64B may be of any suitable thickness. Preferably, the wipers 64A and 64B have a thickness 68 substantially equal to a thickness of the screw flight 22 of the screw to which the tips 50A and 50B are attached.

Although FIGS. 2 and 3 show the bodies 54A and 54B as having a substantially conical shape, it will be appreciated that the bodies 54A and 54B may have any shape suitable for attachment or formation of the wipers 64A and 64B. It will also be appreciated that the phrase “substantially helical” is defined herein as being any portion of a helix extending around any portion of the tip within the range of about 1 degree to about 360 degrees. However, such a substantially helical flight may also extend 360 degrees or greater around the tips 50A and 50B. Preferably, each wiper 64A and 64B has an arcuate length 74 within the range of from about 60 degrees to about 120 degrees when viewed from an end of the tip 50A, as shown in FIG. 4.

It will be also appreciated that the tip 50A and 50B may include any suitable number wipers, such as four wipers. Preferably, the wipers 64A and 64B have a pitch at least as large as a pitch of the flight of the screw to which the tips 50A and 50B are attached. Although only the tip 50A has been illustrated and described in detail, it will be appreciated that the tip 50B is substantially identical to the tip 50A. It will also be appreciated that in a counter-rotating twin screw extruder as shown, one tip will have a forward pitch, and the other tip with have a reverse pitch. Preferably the orientation of the pitch of each of the tips corresponds to the orientation of the pitch of the screw to which the tip is attached, as shown in FIG. 2.

Preferably, the wipers 64A and 64B extend from the surfaces 66A and 66B of the tips 50A and 50B, respectively, and into the flow space 62. The wipers 64A and 64B are spaced a distance 76 from the wall 46 of the adapter 34 and adapted to move material within the flow space 62 as the tips 50A and 50B rotate. Preferably, the wipers 64A and 64B are spaced within the range of from about 0.005 inches to about 0.015 inches from the wall 46 of the adapter 34. The tips 50A and 50B may be coated with a suitable low friction material. Preferably, the tips 50A and 50B are coated with chrome.

In a typical extrusion process, a polymeric material, such as polyvinyl chloride (PVC) or acrylic, in pellet or powder form is introduced into the hopper 12. The polymeric material is carried forwardly from the hopper 12 along the inside of the barrel 16, through the channels 26A and 26B, by the screws 20A and 20B. The working of the material generates heat, and the polymeric material is melted as it proceeds toward the die 28. Additional heat may also be applied though the barrel 16 or through the screws 20A and 20B. Typically, the polymeric material is melted as it is conveyed, preferably by a combination of friction and externally applied heat. The rotating screws 20A and 20B thereby act as a pump and push the material through the barrel 16. As is known, the screws 20A and 20B are adapted to cause the material to flow through the barrel 16 at a first velocity and a corresponding first pressure.

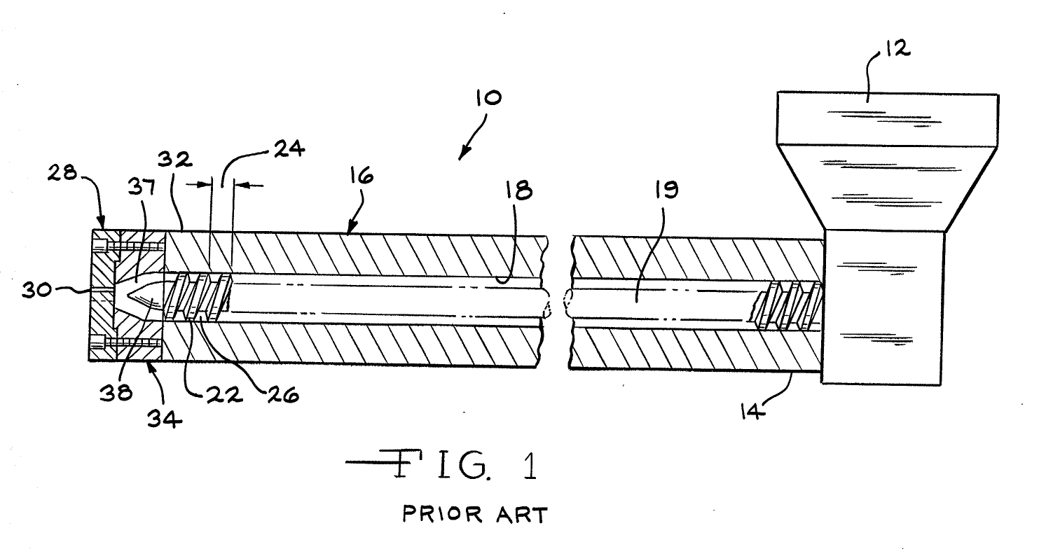

When a material enters the adapter cavity 36 of the prior art extruder of FIG. 1, the material slows from the first velocity to a second, slower velocity, and has a second, lower pressure. At such a slower velocity and lower pressure, a portion of the material may adhere to the inner walls 46 of the adapter cavity 36.

Surprisingly, it has been discovered that the rotating wipers 64A and 64B of tips 50A and 50B cause the material to flow through the adapter cavity 36 at a third velocity and a third pressure greater than the second velocity and the second pressure. Preferably, the third velocity is substantially equal to the first velocity, and the third pressure is substantially equal to the first pressure.

It will be appreciated that one extruder 11, may be used to alternately extrude a higher viscosity material, such as acrylic, and a lower viscosity material, such as PVC. If a lower viscosity material is extruded after a higher viscosity material is first extruded, the lower viscosity material may have insufficient velocity and pressure to move the adhered portion of the preceding higher viscosity material out of the adapter cavity 36 and through an attached die. The higher and lower viscosity materials may also become undesirably mixed. A typical solution prior to the present invention included disassembly and cleaning of the adapter cavity 36 when a change of extrusion materials is desired.

It has been discovered that when the inventive wipers 64A and 64B are used in combination with the prior art extruder shown in FIG. 1, such adherence and mixing of materials is substantially eliminated. Further, it has been discovered that when a higher viscosity material is extruded prior to a lower viscosity material, neither of the higher nor lower viscosity materials adhere to the inner walls 46 of the adapter 34, nor do the materials become mixed. A lower viscosity material can therefore be extruded after a higher viscosity material without the undesirable mixing or commingling of materials, and without the undesirable adhering of material to the inner walls 46 of the adapter 34 typically experienced in prior art extruders. Additionally, because mixing is substantially eliminated and substantially no material adheres to the inner walls 46 of the adapter 34, one extruder can be used to alternately extrude higher and lower viscosity material without being disassembled and cleaned.

Although the illustrated embodiment has twin screws, it will be appreciated that a screw tip 50A and 50B with its respective wiper 64A and 64B, could be used with other extruders, for example, a single screw extruder, or a multiple screw extruder having more than two screws.

The principle and mode of operation of this invention have been described in its preferred embodiments. However, it should be noted that this invention may be practiced otherwise than as specifically illustrated and described without departing from its scope.

What is claimed is:

1. A tip for an extruder screw, the tip comprising:
a body having a first end for attachment to a screw, a second end, and an outer surface; and
a wiper extending outwardly from an outer surface of the body.

2. The tip according to claim 1, wherein the wiper is a substantially helical conveying flight.

3. The tip according to claim 2 including at least two substantially helical conveying flights on the outer surface of the body.

4. The tip according to claim 1, wherein the tip is substantially conically shaped.

5. The tip according to claim 3, wherein the screw includes a substantially helical conveying flight, a pitch of the at least two substantially helical conveying flights of the tip being at least as large as a pitch of the flight of the screw to which the tip is attached.

6. The tip according to claim 1 in combination with a screw.

7. The tip according to claim 1, wherein the wiper has an arcuate length within the range of from about 60 degrees to about 120 degrees when viewed from an end of the tip.

8. An extruder for extruding a material comprising:
a barrel;
a rotatable screw disposed within the barrel;
an adapter mounted to an outlet end of the barrel, the adapter having a wall defining a cavity, an outlet end of the adapter having a reduced cross-sectional area relative to a cross-sectional area of an inlet end of the adapter; and
a tip mounted to an end of the screw and extending into the cavity of the adapter, a flow space being defined between the tip and the wall of the adapter, a wiper extending from a surface of the tip into the flow space, the wiper adapted to move material within the flow space as the tip rotates.

9. The extruder device according to claim 8, wherein the wiper is a substantially helical conveying flight.

10. The extruder according to claim 8 wherein the tip is substantially conically shaped.

11. The extruder according to claim 8, wherein the wiper extends from the surface of the tip into the flow space, the wiper being spaced within the range of from about 0.005 inches to about 0.015 inches from the wall of the adapter.

12. The extruder according to claim 8, wherein the tip includes two wipers extending from a surface of the tip into the cavity of the adapter, each wiper adapted to move material within the flow space as the tip rotates.

13. The extruder according to claim 8, wherein the screw includes a substantially helical conveying flight, the tip including two substantially helical conveying flights, a pitch of the two substantially helical conveying flights of the tip being at least as large as a pitch of the flight of the screw to which the tip is attached.

14. The extruder according to claim 8, wherein the screw is adapted to cause the material to flow through the barrel at a first velocity, the wiper of the tip being adapted to cause the material to flow through the adapter at a second velocity.

15. The extruder according to claim 14 wherein the second velocity is substantially equal to the first velocity.

16. The extruder according to claim 8, wherein the wiper has an arcuate length within the range of from about 60 degrees to about 120 degrees when viewed from an end of the tip.

17. An extruder for extruding a material comprising:
a barrel;
a first rotatable screw disposed within the barrel;
a second rotatable screw disposed within the barrel;
an adapter mounted to an outlet end of the barrel, the adapter having a wall defining a cavity, an outlet end of the adapter having a reduced cross-sectional area relative to a cross-sectional area of an inlet end of the adapter;
a first tip mounted to an end of the first rotatable screw and extending into the cavity of the adapter; and
a second tip mounted to an end of the second rotatable screw and extending into the cavity of the adapter, a flow space being defined between the first and second tips and the wall of the adapter, a first wiper extending from a surface of the first tip into the flow space, the first wiper adapted to move material within the flow space as the first tip rotates, a second wiper extending from a surface of the second tip into the flow space, the second wiper adapted to move material within the flow space as the second tip rotates.

18. The extruder according to claim 17, wherein each of the first wiper and the second wiper is a substantially helical conveying flight.

19. The extruder according to claim 17, wherein each of the first tip and the second tip is substantially conically shaped.

20. The extruder according to claim 17, wherein the first wiper and the second wiper extend from the surface of the first tip and the second tip, respectively, into the flow space, the first wiper and the second wiper being spaced within the range of from about 0.005 inches to about 0.015 inches from the wall of the adapter.

21. The extruder according to claim 17, wherein the each tip includes two wipers extending from a surface of each tip into the cavity of the adapter, each wiper adapted to move material within the flow space as each tip rotates.

22. The extruder according to claim 17, wherein each of the first screw and the second screw includes a substantially helical conveying flight, each of the first tip and the second tip including two substantially helical conveying flights, a pitch of the two substantially helical conveying flights of each tip being at least as large as a pitch of the flight of the screw to which the tip is attached.

23. The extruder according to claim 17, wherein the first and second screws are adapted to cause the material to flow through the barrel at a first velocity, the first wiper and the second wiper being adapted to cause the material to flow through the adapter at a second velocity.

24. The extruder according to claim 23, wherein the second velocity is substantially equal to the first velocity.

25. The extruder according to claim 17, wherein each of the first and the second wiper has an arcuate length within the range of from about 60 degrees to about 120 degrees when viewed from an end of the first tip and the second tip, respectively.
